(19) United States
(12) Patent Application Publication
(10) Pub. No.: US 2008/0314533 A1
(43) Pub. Date: Dec. 25, 2008

(54) Device for Controlling Winding Speed of Winding Roll for Screen or Shade

(75) Inventor: Woo Dae Park, Seoul (KR)

Correspondence Address: MCDERMOTT WILL & EMERY LLP, 18191 VON KARMAN AVE., SUITE 500, IRVINE, CA, 92612-7108, US

(73) Assignee: Dae Sang Window System Co. Ltd., Kyungki-do (KR)

(21) Appl. No.: 11/632,068

(22) PCT Filed: Apr. 14, 2006
(86) PCT No.: PCT/KR2006/001386

§ 371 Date: Jan. 10, 2007

(30) Foreign Application Priority Data
May 6, 2005 (KR) 10-2005-0038087

(51) Int. Cl. E06B 9/56

(52) U.S. Cl. 160/313

(57) ABSTRACT

The invention relates to a device for controlling a winding speed of a winding roll for a screen or shade which adjusts resilience of a torsion spring to increase or decrease the winding speed of the winding roll, preventing mechanical friction with improved operational capability. In the device, a worm wheel is integrally formed in a shaft supporting part receiving an end of the winding shaft, and is rotatably in contact with a stopper plate enclosing a side of an outer shell. Also, an adjustment member having an end penetrating through a front portion of the outer shell is disposed horizontally adjacent to the worm wheel and perpendicular to the winding shaft. Further, the worm wheel is in mesh with a worm integrally formed in a middle portion of the adjustment member.

### TECHNICAL FIELD

The present invention relates to a device for controlling a winding speed of a winding roll for a screen or shade, which effectively controls the winding speed of the winding roll installed in an outer shell to resiliently wind the screen or shade.

This application claims the benefit of Korean Patent Application No. 2005-38087 filed on May 6, 2005, in the Korean Intellectual Property Office, the disclosure of which is incorporated herein by reference.

### BACKGROUND ART

In general, a screen or shade is installed on a window or door to block insects or sunlight. These days, automatic-winding shade or screen featuring a winding roll that resiliently winds or unwinds the shade or screen by resilience of a torsion spring wound around a winding shaft inside a winding box has been developed and well utilized.

A However, such a winding roll winds the screen or shade too slowly or stops the screen or shade in the middle if the torsion spring has weak resilience. On the contrary, if the torsion spring has strong resilience, the winding roll winds up the screen or shade too fast, causing a collision of a handle at the lower end of the screen or shade into the winding box. This increases the breakdown rate and generates noise.

With the aim of solving the above problem, Korean patent No. 0439693 (registered on Jul. 12, 2004) entitled “Device for Adjusting the Springs for Nets of Windows for Protecting Invasion of Insects” has been filed and published prior to this application.

As shown in FIG. 1, in this previously filed invention, a winding shaft for winding an insect-blocking net is operated by a turning force by a spring working in the winding direction of the net inside a winding box 300. Also, a housing 300 having an opening 310 (FIGS. 2 and 3) and a guide groove 311 (FIGS. 2 and 3) formed adjacent to each other at one side thereof is disposed on an upper part of the winding box 200.

The housing 300 has a fastening hole 410 receiving an upper part of the winding shaft 210 in the inside thereof, and a gear bundle 400 consisting of a lower large-circumference flat gear 420 and an upper small-circumference ratchet gear 430 integrally formed therein. Further, an adjustment flap 500 is seated on the guide groove 311 of the housing 300. The adjustment flap 500 has a click 510 adjacent to the ratchet gear 430 so that the ratchet gear 430 is in mesh with the click 510, and a protrusion 520 disposed in the opening 310 of the housing 300 (FIGS. 2 and 3). Further, a plate spring 600 has one end fixed inside the housing 300 and the other end resiliently supporting an end of the adjustment flap 500 so that the click 510 is in mesh with the ratchet gear 430.

In such a device for adjusting the springs for screens of windows for blocking insects, as shown in FIG. 2, when the large-circumference flat gear 420, protruded from the opening 310 of the housing 300, is rotated clockwise, the small-circumference ratchet gear 430 is rotated as it pushes the click 510 of the adjustment flap 500. At this point, the spring is tightened as much as the large-circumference flat gear 420 is rotated such that the spring has increased resilience.

Thus the winding speed of the winding shaft 210 is increased to roll up the insect-blocking net 110 faster. Conversely, as shown in FIGS. 2 and 3, when the adjustment flap 500, protruded toward the opening 310, is pushed, the plate spring 600 is compressed so that the click 510 of the adjustment flap 500 becomes out of mesh with the small-circumference ratchet gear 430. At this point, the large-circumference flat gear 420 is rotated counterclockwise, and the spring is loosened such that it has decreased resilience. Thus the winding speed of the winding shaft 210 is decreased to roll up the inset-blocking net 110 slowly.

However, in such a device for adjusting the springs for the insect-blocking net, rotating the large-circumference flat gear 420 clockwise to tighten the spring to increase resilience results in the small-circumference ratchet gear 430 rotating intermittently as it has friction with the click 510 of the adjustment flap 500, thus hindering the user from quickly increasing the winding speed of the winding shaft 210. Further, not only the constituting parts have shorter lifetime due to repeated friction and accelerated abrasion, but also noise is generated.

In contrast, pushing the adjustment flap 500 to loosen the spring to decrease resilience results in the click being out of mesh with the small-circumference ratchet gear 430, and the large-circumference flat gear 420 is instantly rotated counter-clockwise due to restoring force of the spring. The spring is loosened completely, having no resilience, thus hindering the user from properly decreasing the winding speed of the winding shaft 210. Thus, the user has to bear with the inconvenience of rotating the large-circumference flat gear 420 to tighten the loosened spring over again.

### DISCLOSURE OF INVENTION

### Technical Problem

The present invention has been made to solve the foregoing problems of the prior art and it is therefore an object of the present invention to provide a high-quality device for controlling a winding speed of a winding roll for a screen or shade in which the resilience of a torsion spring is adjusted by worm gear driving method to adjust the winding speed of the winding roll so that there is no mechanical friction generated between the constituent parts.

It is another object of the invention to provide a device for controlling a winding speed of a winding roll for a screen or shade in which the resilience of a torsion spring is adjusted by worm gear driving method to adjust the winding speed of the winding roll so that its operational capability is significantly improved.

### Technical Solution

According to an aspect of the invention for realizing the object, there is provided a device for controlling a winding speed of a winding roll for a screen or shade including:

an outer shell;

a torsion spring wound on a winding shaft installed inside the outer shell;

a winding roll installed around the winding shaft to resiliently rotate by the torsion spring;

a worm wheel integrally formed with a shaft supporting part, receiving an end of the winding shaft;

a worm in mesh with the worm wheel, wherein an end of the worm wheel is rotatably in contact with an inner side of a stopper plate enclosing a side of the outer shell; and

an adjustment member disposed horizontally adjacent to the worm wheel and perpendicular to the winding shaft, having a front end penetrating through a front portion of the outer shell to the outside, wherein the worm is integrally formed in a middle part in a longitudinal direction of the adjustment member to be in mesh with the worm wheel.

### Advantageous Effects

In the present invention, the resilience of a torsion spring is adjusted by a worm gear to increase or decrease a winding speed of a winding roll. Therefore, the invention allows the user to adjust the winding speed of the winding roll quickly, quietly and more conveniently while extending lifetime of the device.

### BRIEF DESCRIPTION OF THE DRAWINGS

FIG. 1 is a perspective view of major parts of a conventional device for adjusting the springs for an insect-blocking net;

FIGS. 2 and 3 illustrate the operation of the conventional device for adjusting the springs for an insect-blocking nets;

FIG. 4 is an exploded perspective view illustrating a device for controlling a winding speed of a winding roll for a screen or shade according to the present invention;

FIG. 5 is a front sectional view of the device for controlling a winding speed of a winding roll for a window screen or shade according to the present invention;

FIG. 6 is a side sectional view of the device for controlling a winding speed of a winding roll for a window screen or shade according to the present invention;

FIGS. 7 and 8 are longitudinal sectional views illustrating the operation of the device for controlling a winding speed of a winding roll for a window screen or shade according to the present invention; and

FIG. 9 is a partially cutaway plan view illustrating a variation to the device for controlling a winding speed of a winding roll for a window screen or shade according to the present invention.

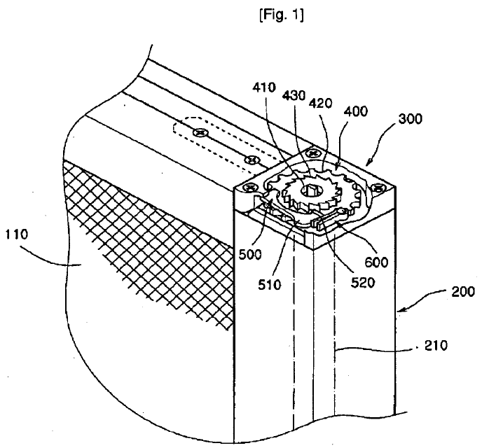

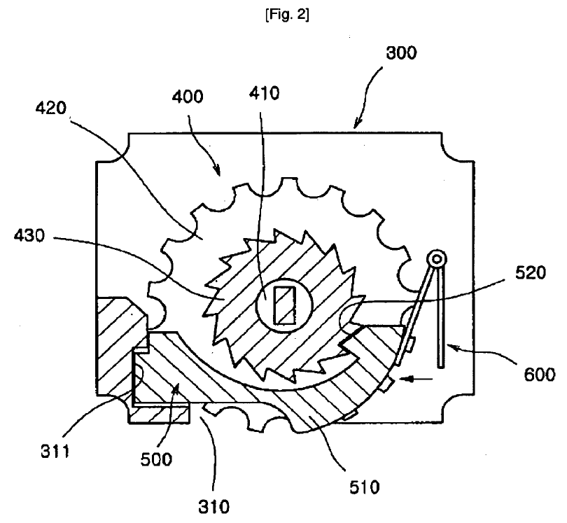

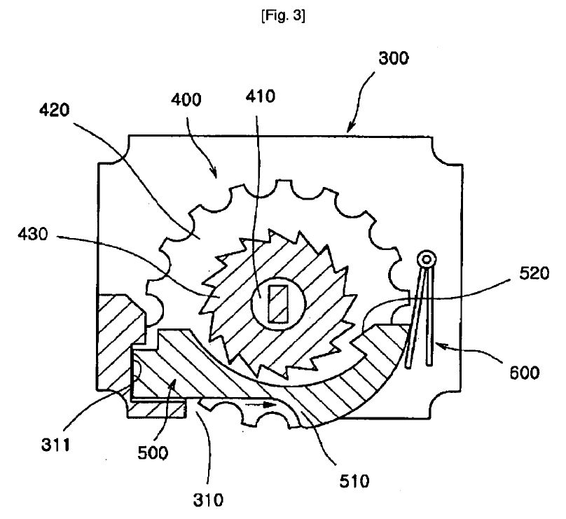

### BEST MODE FOR CARRYING OUT THE INVENTION

In the present invention, there is provided a device for controlling a winding speed of a winding roll for a screen or shade including:

an outer shell;

a torsion spring wound on a winding shaft installed inside the outer shell;

a winding roll installed around the winding shaft to resiliently rotate by the torsion spring;

a worm wheel integrally formed with a shaft supporting part, receiving an end of the winding shaft;

a worm in mesh with the worm wheel, wherein an end of the worm wheel is rotatably in contact with an inner side of a stopper plate enclosing a side of the outer shell; and

an adjustment member disposed horizontally adjacent to the worm wheel and perpendicular to the winding shaft, having a front end penetrating through a front portion of the outer shell to the outside, wherein the worm is integrally formed in a middle part in a longitudinal direction of the adjustment member to be in mesh with the worm wheel.

### Mode for the Invention

A device for controlling a winding speed of a winding roll for a screen or shade according to the present invention shares the technical concept with a conventional one in that a winding speed of a winding roll 2 resiliently rotated around a winding shaft 3 is controlled using a torsion spring B wound on the winding shaft 3 installed inside an outer shell 1.

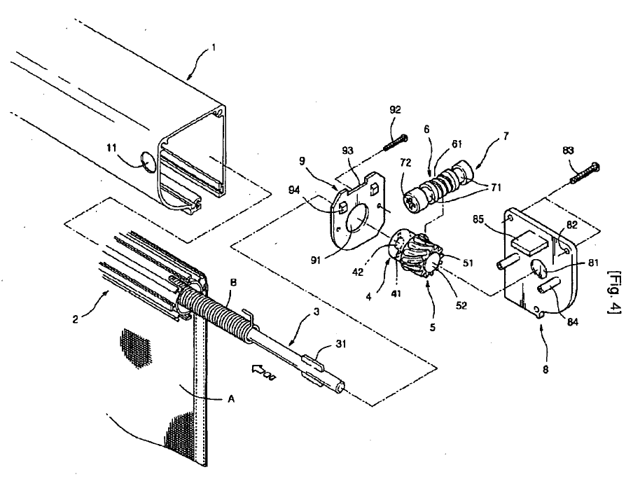

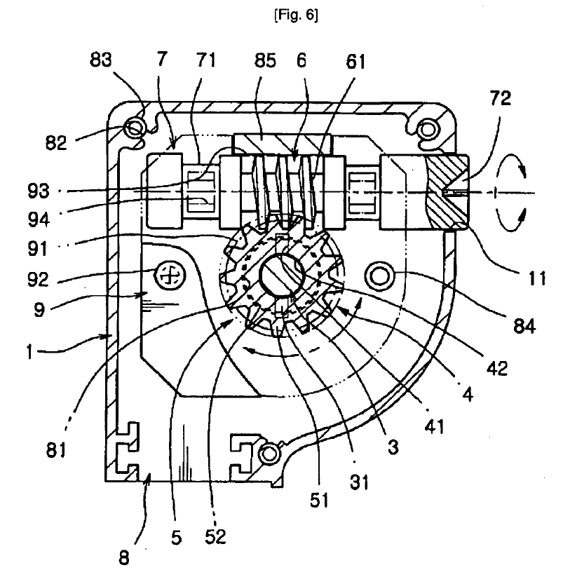

In addition to the above features, as shown in FIGS. 4 to 6, the device for controlling the winding speed of the winding roll for the screen or shade according to the present invention has technical features of its own as follows. A worm wheel 5 is integrally formed with a shaft supporting part 4 receiving an end of the winding shaft 3, an end of the worm wheel 5 is rotatably in contact with an inner side of a stopper plate 8 enclosing a side of the outer shell 1. In addition, an adjustment member 7, disposed horizontally adjacent to the worm wheel 5, and perpendicular to the winding shaft 3, has a front end penetrating through a front portion of the outer shell 1 to the outside, and a worm 6 integrally formed in a middle portion in a longitudinal direction of the adjustment member 7 to be in mesh with the worm wheel 5.

In a preferred embodiment, the basic configuration of the invention includes an outer shell 1 having an empty space therein, a winding roll 2 for winding up or down a window screen or shade A, a winding shaft 3 for resiliently rotating the winding roll 2 and a torsion spring B. These are basic components identical to those of the prior art, and thus a detailed explanation on them will be omitted. Therefore, the following explanation will be centered on the technical features of the present invention including a shaft supporting part 4, a worm 6, a worm wheel 5, an adjustment member 7, and a stopper plate 8.

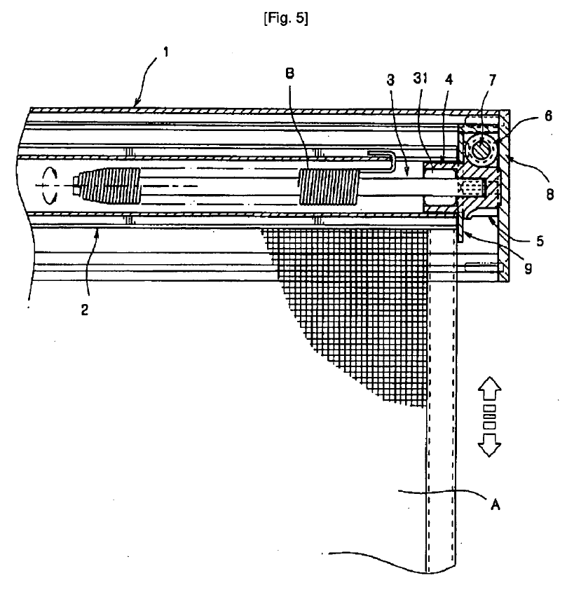

As shown in FIGS. 4 and 5, the shaft supporting part 4 is a cylinder with a fastening hole 42 having a pair of keyways 41 in the cross-section thereof. An end of the winding shaft 3 with a pair of keys 31 is inserted into the shaft supporting part 4 through the fastening hole 42 having the keyways 41 of the shaft supporting part 4.

As shown in FIGS. 4 to 6, the worm wheel 5 has gear teeth 51 which are formed around a circumferential surface of its cylindrical body and has a larger circumference than the shaft supporting part, and is rotatably in contact with the stopper plate 8 enclosing an end of the outer shell 1. The worm 6 also has gear teeth 61 around a circumferential surface in a middle portion in a longitudinal direction of the adjustment member 7 disposed perpendicular to the winding shaft 3.

Thus, the gear teeth 61 of the worm 6 are in mesh with the torsion gear teeth 51 of the worm wheel 5. Here, the adjustment member 7 can be operated by an end penetrating to the outside through an opening 11 formed in a front portion of the outer shell. When the adjustment member 7 is operated by the end penetrated through the front portion of the outer shell 1, the worm wheel 5 in conjunction with the worm 6 rotates the winding shaft 3 which is received in the shaft supporting part 4 integrally formed with the worm wheel 5, thereby adjusting the resilience of the torsion spring B.

In addition, a circular insertion plate 52 is protruded from an end of the worm wheel 5, and an insertion recess 81 is formed in a center of an inner surface of the stopper plate 8 enclosing one side of the outer shell 1. The circular insertion plate 52 of the worm wheel 5 is fitted into the insertion recess 81 of the stopper plate 8, so that the shaft supporting part 4 and the winding shaft 3 rotate freely in conjunction with the worm wheel 5. Here, the stopper plate 8 is fastened to an end of the outer shell 1 with a plurality of fastening screws 83 inserted through holes 82 formed in the upper and lower portions of the stopper plate 8.

In addition, it is preferable that the leading end of the worm wheel 5 is fixed by a vertical fixing plate 9 which is fitted around an outer surface of the shaft supporting part 4 through an opening formed in a center thereof and which is butted against fixing pillars 84 protruded from an inner surface of the stopper plate 8 and fastened to the stopper plate 8 by fixing screws 92 penetrating through the vertical fixing plate 4 and the fixing pillars 84, thereby allowing the worm wheel 5 to rotate freely and stably in position without play.

Moreover, the upper end of the worm 6 is fixed by a fixing flap 85 which is laterally protruded from an upper part of the stopper plate 8 and fitted into a recess 93 formed on an upper end of the vertical fixing plate 9, allowing the adjustment member 7 and the worm 6 to rotate freely and stably in position without play.

Here, it is preferable that annular grooves 71 are formed on opposed sides next to the worm 6 located in the center of the adjustment member 7, and bumps 94 protruded from the upper part of the inner surface of the vertical fixing plate 9 are fitted into the grooves 71 of the adjustment member 7, allowing the worm 6 to rotate precisely without moving back and forth.

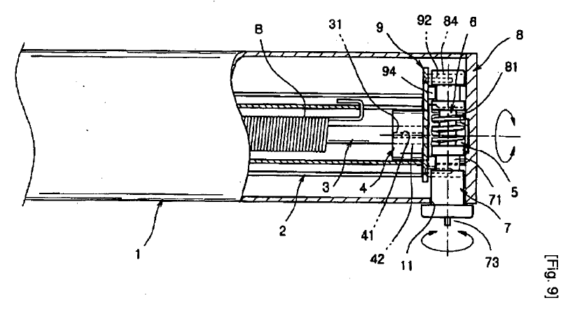

The preferred embodiment exemplifies that a tool groove 72 is formed on a front end of the adjustment member 7 so that the adjustment member 7 can be operated by a tool such as a driver. But if necessary, as shown in a variation in FIG. 9, a handgrip 73 can be installed on the front end of the adjustment member 7 to manually operate the adjustment member 7 with convenience.

Now, the operation of the device for controlling the winding speed of the winding roll for a screen or shade will be explained hereinbelow.

At ordinary times, the winding shaft 3 tends to rotate back by the resilience of the torsion spring B. But because the worm wheel 5 formed integrally with the shaft supporting part 4 coupled with the winding shaft 3 is in mesh with the worm integrally formed in a middle portion of the adjustment member 7, the winding shaft 3 is hindered from rotating back and is maintained in one position.

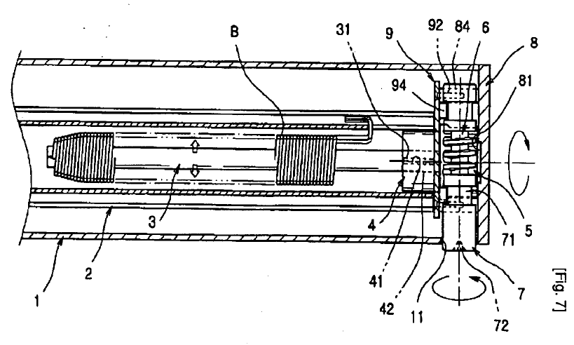

As shown in FIG. 7, as the adjustment member 7 having one end penetrating through a front portion of the outer shell 1 is rotated counterclockwise, the worm 6 integral with the adjustment member 7 is rotated counterclockwise. Then, the worm wheel 5 in mesh with the worm 6 is rotated forward, and accordingly, the winding shaft 3 integrally bound with the worm wheel 5 is rotated forward. Consequently, as much as the resilience of the torsion spring B is increased, the winding speed of the winding roll 2 is increased, and thereby the screen or shade is wound up faster.

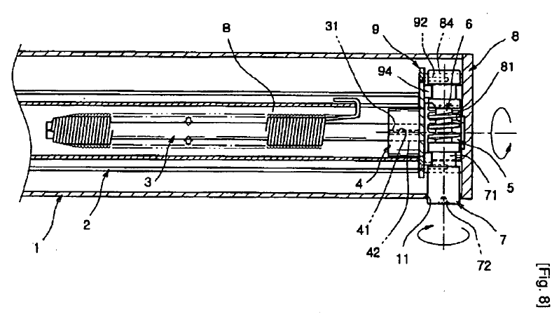

Conversely, as shown in FIG. 8, when the adjustment member 7 having one end penetrating through the front portion of the outer shell 1 is rotated clockwise, the worm 6 integral with the adjustment member 7 is rotated clockwise, and thereby the worm wheel in mesh with the worm 6 is rotated backward. Accordingly, the winding shaft 3 coupled with the shaft supporting part 4 integral with the worm wheel is rotated backward, thereby decreasing the resilience of the torsion spring B. Consequently, as much as the resilience of the torsion spring B is decreased, the winding speed of the winding roll 2 is decreased, and thereby the screen or shade A is wound up slowly.

According to the present invention, the device for controlling the winding speed of the winding roll for the window or shade is configured to increase or decrease the winding speed of the winding roll 2 by adjusting the resilience of the torsion spring B rotated by the worm 6 and worm wheel 5 operated together. The invention prevents mechanical friction or noise when adjusting the resilience of the torsion spring B, allowing the user to adjust the winding speed of the winding roll 2 quickly and quietly and extending lifetime of the device. Also, the user can adjust the resilience of the torsion spring B more precisely and finely, thereby conveniently adjusting the speed of the winding roll 2.

While the present invention has been shown and described in connection with the preferred embodiments, it will be apparent to those skilled in the art that modifications and variations can be made without departing from the spirit and scope of the invention as defined by the appended claims.

### INDUSTRIAL APPLICABILITY

In the present invention, the resilience of a torsion spring is adjusted by a worm gear to increase or decrease a winding speed of a winding roll. Therefore, the invention allows the user to adjust the winding speed of the winding roll quickly, quietly and more conveniently while extending lifetime of the device.

1. A device for controlling a winding speed of a winding roll for a screen or shade comprising:
an outer shell;
a torsion spring wound on a winding shaft installed inside the outer shell;
a winding roll installed around the winding shaft to resiliently rotate by the torsion spring;
a worm wheel integrally formed with a shaft supporting part, receiving an end of the winding shaft;
a worm in mesh with the worm wheel, wherein an end of the worm wheel is rotatably in contact with an inner side of a stopper plate enclosing a side of the outer shell; and
an adjustment member disposed horizontally adjacent to the worm wheel and perpendicular to the winding shaft, having a front end penetrating through a front portion of the outer shell to the outside, wherein the worm is integrally formed in a middle part in a longitudinal direction of the adjustment member to be in mesh with the worm wheel.

2. The device for controlling a winding speed of a winding roll for a screen or shade according to claim 1, wherein a circular insertion plate is protruded from the end of the worm wheel, and an insertion recess is formed in a center of the inner side of the stopper plate, so that the circular insertion plate is inserted into the insertion recess.

3. The device for controlling a winding speed of a winding roll for a screen or shade according to claim 1, wherein a leading end of the worm wheel is fixed by a vertical fixing plate which is fitted around an outer surface of the shaft supporting part through an opening formed in a center thereof and which is butted against fixing pillars protruded from an inner surface of the stopper plate and fastened to the stopper plate by fixing screws penetrating through the vertical fixing plate and the fixing pillars.

4. The device for controlling a winding speed of a winding roll for a screen or shade according to claim 1 or 3, wherein annular grooves are formed on the adjustment member, next to opposite ends of the worm located in the center on the adjustment member, and two projections protruding from an upper part of an inner surface of the vertical fixing plate are fixed into the grooves.

5. The device for controlling a winding speed of a winding roll for a screen or shade according to claim 1, wherein a tool groove is formed on a front end of the adjustment member.

6. The device for controlling a winding speed of a winding roll for a screen or shade according to claim 1, a handgrip is additionally installed on a leading end of the adjustment member.
